(19) United States
(12) Patent Application Publication
(10) Pub. No.: US 2020/0213280 A1
(43) Pub. Date: Jul. 2, 2020

(54) SWITCH-BASED DATA ANONYMIZATION

(71) Applicant: Intel Corporation, Santa Clara, CA (US)

(72) Inventors: Francesc GUIM BERNAT, Barcelona (ES); Karthik KUMAR, Chandler, AZ (US); Alexander BACHMUTSKY, Sunnyvale, CA (US)

(73) Assignee: Intel Corporation, Santa Clara, CA (US)

(21) Appl. No.: 16/815,389

(22) Filed: Mar. 11, 2020

(51) Int. Cl. H04L 29/06; G06F 21/72; G06N 3/063

(52) U.S. Cl. CPC H04L 63/0421; G06N 3/063; G06F 21/72

(57) ABSTRACT

Examples may include a packet processor (such as a switch) including accelerator circuitry such as at least one field programmable gate array (FPGA) or artificial intelligence (AI) core; and a data anonymizer. The data anonymizer is configured to identify a type of a packet received by the packet processor, get a tenant key based at least in part on the packet type or a tenant identifier (ID); decrypt the packet data using the tenant key, provide the decrypted packet data to a selected bitstream programmed into the accelerator circuitry, execute the selected bitstream in the accelerator circuitry to anonymize the packet data, encrypt the anonymized packet data using the tenant key, and transmit the packet including the anonymized packet data according to a mask.

### TECHNICAL FIELD

Examples described herein are generally related to processing of packets in a computing system.

### BACKGROUND

In digital communications networks, packet processing refers to the wide variety of techniques that are applied to a packet of data or information as it moves through the various network elements of a communications network. There are two broad classes of packet processing techniques that align with the standardized network subdivisions of control plane and data plane. The techniques are applied to either control information contained in a packet which is used to transfer the packet safely and efficiently from origin to destination or the data content (frequently called the payload) of the packet, which is used to provide some content-specific transformation or take a content-driven action. Within any network enabled device (e.g., router, switch, firewall, network element or terminal such as a computer or smartphone) it is the packet processing subsystem that manages the traversal of the multi-layered network or protocol stack from the lower, physical and network layers all the way through to the application layer.

As advertising and analytics efforts implemented in data centers become increasingly targeted and personalized, the value of data communicated in packets continues to increase. Data anonymization has emerged as an enabling capability that bridges what would otherwise be two somewhat conflicting objectives: providing person-specific information to advertising and analytics services; and preserving individual privacy by de-personalizing the information provided to the advertising and analytics services. Anonymization involves removal of specific identifier information determined a priori as information that can identify a person, while preserving other information that is useful to advertiser and analytics services such as age group/demographics/income group, etc.

With the increase in real-time usages, providing anonymized data as a continuous stream of data in real-time so that further analysis can be performed is a challenge. For example, a cloud service provider may offer a data anonymization service for data streaming within and beyond the data center. In such usages, there is limited value in anonymizing data that is static or old. The data that is typically of most interest to advertisers and analytics providers is data that is current (e.g., “hot”) and currently accessed by applications (e.g., video streaming services, medical applications, etc.).

### BRIEF DESCRIPTION OF THE DRAWINGS

FIG. 1 illustrates an example of a packet processing system.

FIG. 2 illustrates an example of packet processing components in a computing platform.

FIG. 3 illustrates an example apparatus.

FIG. 4 illustrates an example packet processor according to some embodiments.

FIG. 5 illustrates an example anonymization configuration table according to some embodiments.

FIG. 6 illustrates an example flow diagram of packet processing according to some embodiments.

FIG. 7 illustrates an example computing platform.

FIG. 8 illustrates an example of a storage medium.

FIG. 9 illustrates another example computing platform.

### DETAILED DESCRIPTION

As contemplated in the present disclosure, a data anonymization architecture is provided where packet processing devices (such as switches), as aggregation points across multiple processing nodes in a data center, anonymize data in packets based on predefined anonymization operations and transmit the packets to destinations. In an embodiment, a switch includes accelerator circuitry, including one or more of field programmable gate arrays (FPGAs) and/or artificial intelligence (AI) cores, to execute bitstreams on packets to anonymize the data in packet payloads. The switch receives encrypted packets coming from services running on compute nodes in a data center, decrypts the packets, optionally performs analysis of packet data depending on packet flow type, anonymizes the packet data depending on packet flow type, re-encrypts the packets (now including anonymized packet data), and transmits the packets to destinations.

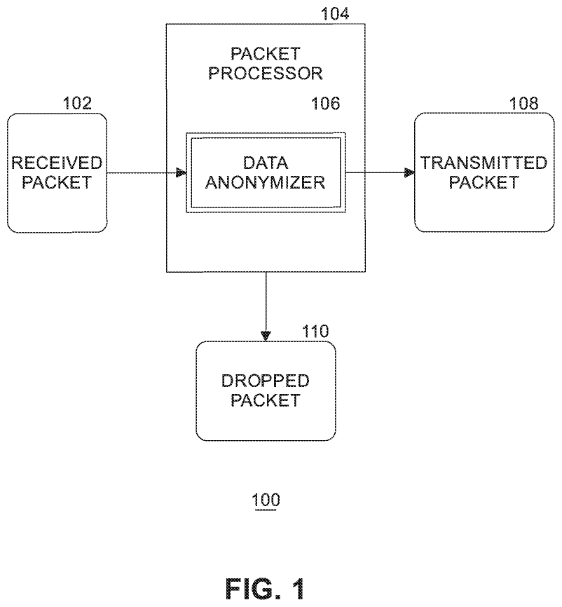

FIG. 1 illustrates an example of a packet processing system 100. A packet includes a packet header and a packet payload. In embodiments, packet processor component 104 examines a received packet 102 by performing data anonymization processing by data anonymizer 106 to one or more of the packet header and packet payload. Based on analysis of the packet, packet processor 104 either transmits the packet (e.g., as transmitted packet 108) onward in a computing system for further processing or drops the packet (shown as dropped packet 110 in FIG. 1) whereby the packet is discarded and deleted, resulting in no further processing of the dropped packet. In embodiments of the present invention, data in transmitted packet 108 is anonymized.

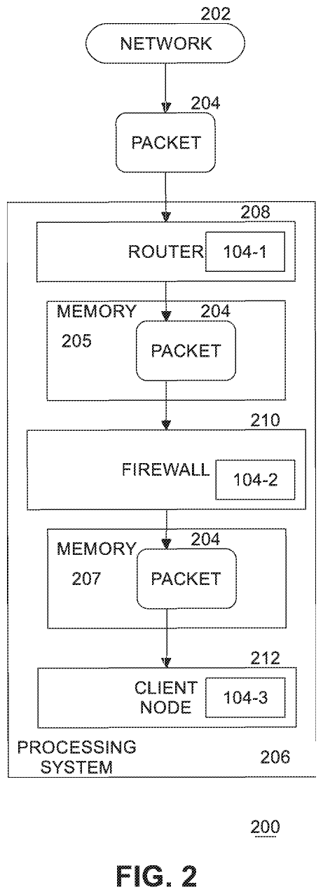

FIG. 2 illustrates an example of packet processing components in a computing platform. An incoming packet 204 is received from a network 202, such as the Internet, for example, by processing system 206. Processing system 206 may be any digital electronics device capable of processing data. In one embodiment, processing system 206 is a cloud computing system in a data center. Processing system 206 includes one or more components that processes packet 204.

For example, processing system 206 includes router 208. Router 208 is a networking device that forwards data packets between computer networks. Routers perform the traffic directing functions on the Internet. A data packet is typically forwarded from one router to another router through the networks that constitute an internetwork until it reaches its destination node. A router is connected to two or more data lines from different networks. When a data. packet comes in on one of the lines, the router reads the network address information in the packet to determine the ultimate destination. Then, using information in its routing table or routing policy, it directs the packet to the next network on its journey. The most familiar type of routers are home and small office routers that simply forward Internet Protocol (IP) packets between the home computers and the :Internet. An example of a router would be the owner's cable or DSL router, which connects to the Internet through an Internet service provider (ISP). More sophisticated routers, such as enterprise routers, connect large business or ISP networks up to the powerful core routers that forward data at high speed along the optical fiber lines of the Internet backbone.

In an embodiment, router 208 includes packet processor 104-1 (e.g., an instantiation of packet processor 104, to perform, at least in part, packet data anonymization according to some embodiments). Router 208 provides perimeter protection. Router 208 forwards packet 204 to firewall 210. In an embodiment, packet 204 is stored, at least temporarily, in memory 205. In another embodiment, route 208 may be replaced by a switch.

For example, processing system 200 also includes firewall 210. Firewall 210 is a network security system that monitors and controls incoming and outgoing network traffic based on predetermined security rules. A firewall typically establishes a barrier between a trusted internal network and untrusted external network, such as the Internet. Firewalls are often categorized as either network firewalls or host-based firewalls. Network firewalls filter traffic between two or more networks and run on network hardware. Host-based firewalls run on host computers and control network traffic in and out of those machines.

In an embodiment, firewall 210 includes packet processor 104-2 (e.g., an instantiation of packet processor 104, to perform, at least in part, packet data anonymization according to some embodiments). Firewall 210 provides inner layer protection. Firewall 210 forwards packet 204 to client node 212. In an embodiment, packet 204 is stored, at least temporarily, in memory 207. In an embodiment, memory 205 and memory 207 may be the same memory.

For example, processing system 200 also includes client node 212. Client node 212 may be a computing system such as a laptop or desktop personal computer, smartphone, tablet computer, digital video recorder (DVR), computer server, web server, consumer electronics device, or other content producer or consumer.

In an embodiment, client node 212 includes packet processor 104-3 (e.g., an instantiation of packet processor 104, to perform, at least in part, packet data anonymization according to some embodiments). Client node 212 provides node protection.

Although router 208, firewall 210, and client node 212 are all shown in the example processing system 206 in a pipeline design, packet processor 104 according to the present disclosure may be included “stand-alone” in processing system 206, or in any combination of zero or more of router/switch 208, firewall 210, client node 104, or in other components in processing system 206 (e.g., anywhere in the cloud). In the example shown in FIG. 2, once packet processor 104-1 in router 208, packet processor 104-2 in firewall 210, and packet processor 104-3 in client node 212 all examine and pass the packet, then client node 212 can use the packet's anonymized payload for further processing in the client node. In various embodiments, router/switch 208, firewall 210, and client node 212 are implemented by one or more of hardware circuitry, firmware, and software, including network virtualized functions (NVFs). In embodiments described herein, the data in packet 204 is anonymized.

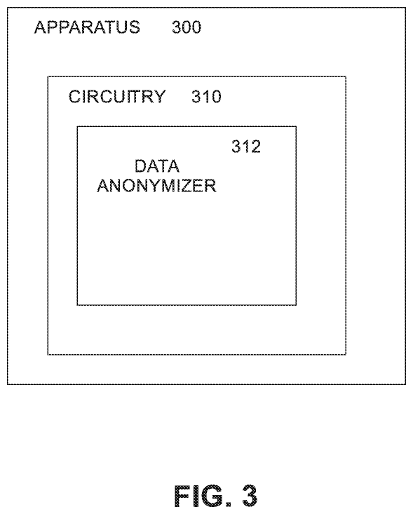

FIG. 3 illustrates an example apparatus. Although apparatus 300 shown in FIG. 3 has a limited number of elements in a certain topology, it may be appreciated that the apparatus 300 may include more or less elements in alternate topologies as desired for a given implementation.

According to some examples, apparatus 300 is associated with logic and/or features of data anonymizer 312. In an embodiment, data anonymizer 312 is implemented as packet processor 104 as shown in FIG. 1, and/or packet processor 104-1, 104-2, and 104-3 as shown in FIG. 2, hosted by a processing system such as processing system 206, and supported by circuitry 310. For these examples, circuitry 310 is incorporated within one or more of circuitry, processor circuitry, a processing element, a processor, a central processing unit (CPU) a core maintained at processing system 206, one or more FPGAs, or and/one or more AI cores. Circuitry 310 is arranged to execute one or more software, firmware or hardware implemented modules, components or data analyzer and anonymizer 312. Module, component or logic may be used interchangeably in this context. The examples presented are not limited in this context and the different variables used throughout may represent the same or different integer values. Also, “logic”, “module” or “component” also includes software/firmware stored in computer-readable media, and although the types of logic are shown in FIG. 3 as discrete boxes, this does not limit these components to storage in distinct computer-readable media components (e.g., a separate memory, etc.).

Circuitry 310 is all or at least a portion of any of various commercially available processors, including without limitation an Intel® Atom®, Celeron®, Core (2) Duo®, Core i3, Core i5, Core i7, Itanium®, Pentium®, Xeon®, Xeon Phi® and XScale® processors; processors commercially available from Applied Micro Devices, Inc. (AMD), or similar processors, or Advanced Reduced Instruction Set Computing (RISC) Machine (ARM) processors. According to some examples, circuitry 310 also includes an application specific integrated circuit (ASIC) and at least some of data anonymizer 312 is implemented as hardware elements of the ASIC. According to some examples, circuitry 310 also includes a field programmable gate array (FPGA) and at least some of data anonymizer 312 is implemented as hardware elements of the FPGA. According to some examples, circuitry 310 also includes an AI core and at least some of data anonymizer 312 is implemented as hardware elements of the AI core. As used herein, AI core comprises an AI accelerator application specific integrated circuit (ASIC) to accelerate AI applications, such as artificial neural networks, machine vision, and machine learning.

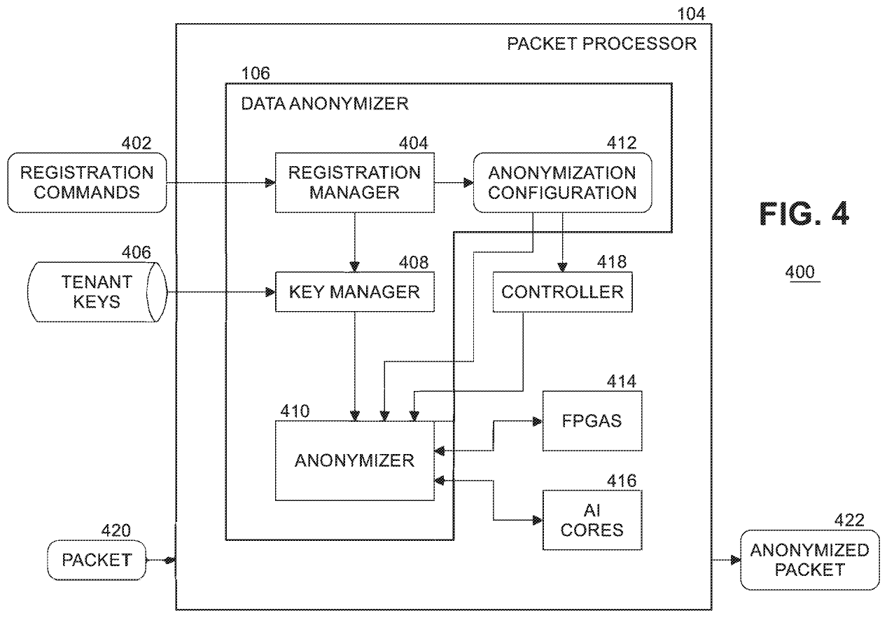

According to some examples, apparatus 300 includes data anonymizer 312. Data anonymizer 312 is executed or implemented by circuitry 310 to perform processing as described with reference to FIGS. 4-6 described below.

Various components of apparatus 300 may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Example connections include parallel interfaces, serial interfaces, and bus interfaces.

In embodiments of the present invention, a packet processing device 104 (called a switch herein, but the packet processing device could also comprise a router, firewall, or other computing device), exposes a mechanism providing for registration of bitstreams that are mapped to specific types of packet flows. Execution of a bitstream in the switch includes one or more of performing analytics on the data and anonymizing the data. Different bitstreams may be selected depending on the destination of the packet flow, using network masks or a final destination Internet Protocol (IP) address. A list of packet flow types may be defined by a system administrator of the data center.

As used herein a bitstream includes programming instructions or code for accelerator circuitry such as an FPGA, AI core, special purpose application specific integrated circuits (ASICs), or inference engines. Special purpose accelerator circuitry such as an FPGA or AI core is programmed using a specific bitstream in order for the FPGA or AI core to operate as an embedded hardware platform for a specific purpose. Bitstreams are stored in non-volatile memory (such as memory 205 or 207) and one or more components of processing system 206 program the accelerator circuitry with the bitstream. In an embodiment, a bitstream is coded to, when executed, anonymize selected packet data according to known packet formats. For example, assume a packet includes identifying information about a patient for use in a medical application, such as MSG_Payload={UserID INT8, Temperature INT64, HeartRate INT64}, where UserID uniquely identifies a patient. In this example, the bitstream, when executed, anonymizes the packet by removing the unique patient information. The packet may then be, for example, MSG_Anonym={000000, Temperature INT64, HeartRate INT64}. In another example, assume a packet includes a location of a sensor in an Internet of Things (IoT) application, such as MSG Payload={SensorID INT8, Temperature INT64, Location INT64}, where Location identifies the specific geographic location of the sensor. In this example, the bitstream, when executed, anonymizes the packet by removing the geographic location information. The packet may then be, for example, MSG_Anonym={SensorID, Temperature INT64, 000}.

The switch exposes a mechanism that allows applications to register new packet flows from a component of processing system 206. Each packet flow has an associated packet flow type describing the type of data in the packets. The registration includes specifying at least a private key (e.g., a symmetric key) for performing transport layer security (TLS) connections and the type of packet flow. The switch executes the bitstreams in inline mode depending on the type of packet flow (after decrypting packet data), optionally performs analytics on the data, performs anonymization on the data depending on the type of packet flow (using a selected bitstream), and secures the data with TLS for the packet flow.

In an embodiment, anonymization is performed on a single packet. In some cases, packet data from data center services (e.g., applications) may be split into multiple packets. In other embodiments, anonymization is performed on multiple (e.g., related) packets at a time.

In some current network software (SW) stacks, the type of packet flow may be specified and implemented for a particular connection. In embodiments of the present invention, regardless of the processing system configuration, anonymization is performed in a hardware (HW) accelerated manner. This provides better packet anonymization efficiency, better data center resource utilization, and better management and deployment of anonymization at large scale in data centers.

FIG. 4 illustrates an example packet processor 104 according to some embodiments. In system 400 of FIG. 4, packet processor (such as a switch) receives packet 420, anonymizes the data in the packet, and transmits anonymized packet 422. Packet processor 104 includes controller 418 to manage processing performed by the packet processor, and special purposes accelerator circuitry such as at least one of a FPGA 414 and AI core to execute bitstreams to process packets. In some embodiments, there may be many FPGAs and/or AI cores in packet processor 104. In other embodiments, other types of accelerator circuitry, including special purpose application specific integrated circuits (ASICs) may be used. Packet processor 104 includes data anonymizer 106 to register bitstreams, manage keys, and manage bitstreams for anonymization of data in packets. Registration manager 404 accepts registration commands 402 from one or more tenants (where a tenant is a user of packet processor 104 for a particular packet flow) to register selected bitstreams that are mapped to specific types of packet flows. Bitstreams may also be deregistered as needed. In one embodiment, a registration command includes a private key (to perform a TSL connection) and the type of packet flow. The registration interface allows a service running in the data center (e.g., an application known as a tenant) to specify a particular packet flow and/or connection. Packets in the flow are encoded as a particular packet flow type, secured with the private key, and may specify a target/destination for the connection according to a mask. Note that the target/destination may be determined by inspecting the packet header. A private key may be associated with a tenant by a tenant ID and stored in tenant keys 406.

An example of setting a tenant ID and a registration command is:

p0 TenantID=TenantName01
RegistrationCommand={BitstreamToApply=AnonymizerBinaryCode, Mask=10.10.2.255, PacketFlowType=SensorData}

Examples of packet flow types include health care medical patient records, solar farm sensor data, and so on. Other packet flow types may also be used, depending on applications and associated data types. In an embodiment, registration information resulting from processing registration commands 402 by registration manager 404 is stored in anonymization configuration 412. Anonymization configuration may be stored in a memory (not shown) of packet processor 104. In an embodiment, anonymization configuration is implemented as a table, but other data structures may also be used.

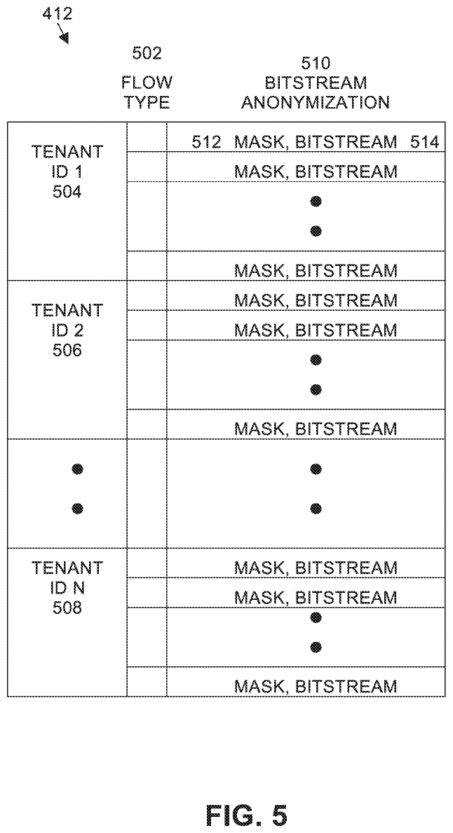

FIG. 5 illustrates an example anonymization configuration table 412 according to some embodiments. Anonymization configuration 412 includes a plurality of rows for tenants registering for bitstreams, with each row identifying the tenant. For example, anonymization configuration 412 includes sections for tenant ID 1 504, tenant ID 2 506, . . . tenant ID N 508, where N is a natural number. Each tenant section of anonymization configuration table 412 includes zero or more entries, with each entry including packet flow type 502, a mask 512 and bitstream 514 combination. In an embodiment, a mask 512 comprises a destination IP address (e.g., 10.12.1.255). When applied, the mask filters packets targeting the network at 10.12.1.***, for example. In one embodiment, a destination mask may use known IP protocols to identify destinations for transmission of packets. Bitstream 514 comprises a sequence of instructions to be executed by accelerator circuitry such as one or more of FPGAs 414 and/or AI cores 416. In an embodiment, bitstreams are binaries. Thus, each tenant can register for selected bitstreams and masks for selected packet flow types. In one embodiment, anonymization configuration table 412 may optionally also include a column for data analytics operation bitstreams. Analytics bitstreams are executed by the accelerator circuitry such as one or more of FPGAs 414 and/or AI cores 416 to perform any specified data analytics operations on decrypted packet data either before or after anonymization.

Turning back to FIG. 4, key manager 408 receives one or more tenant keys 406 from an orchestration system (not shown) or a system administrator via tenant keys 406. In an embodiment, one or more tenant keys 406 are received in registration commands 402. In another embodiment, registration commands 402 includes a tenant ID, which is associated with a tenant key by key manager 408. A selected private key for a tenant from tenant keys 406 is used to perform TSL connections. The private key is also used to decrypt and re-encrypt packet data by anonymizer 410. In an embodiment, key manager 408 stores private keys and associates the private keys with tenant IDs (e.g., a key is associated per a packet flow of a tenant (which is mapped into a TLS flow)). Anonymizer 410 manages receipt of registration commands and keys (e.g., using registration manager 404 and key manager 408) and loads registered bitstreams from anonymization configuration 412 to configure accelerator circuitry such as one or more of FPGAs 414 and/or AI cores 416, based at least in part on tenant IDs of packets, packet flow types, and associated masks. Once registered bitstreams are loaded into the accelerator circuitry such as one or more of FPGAs 414 and/or AI cores 416, when a packet is received by the accelerator circuitry to execute an appropriate bitstream (as indicated by tenant ID, packet flow type, and mask) to process the packet. In an embodiment, since the executing bitstream performs one or more of analytics and/or anonymization operations on the packet, the output of packet processor 104 is anonymized packet 422.

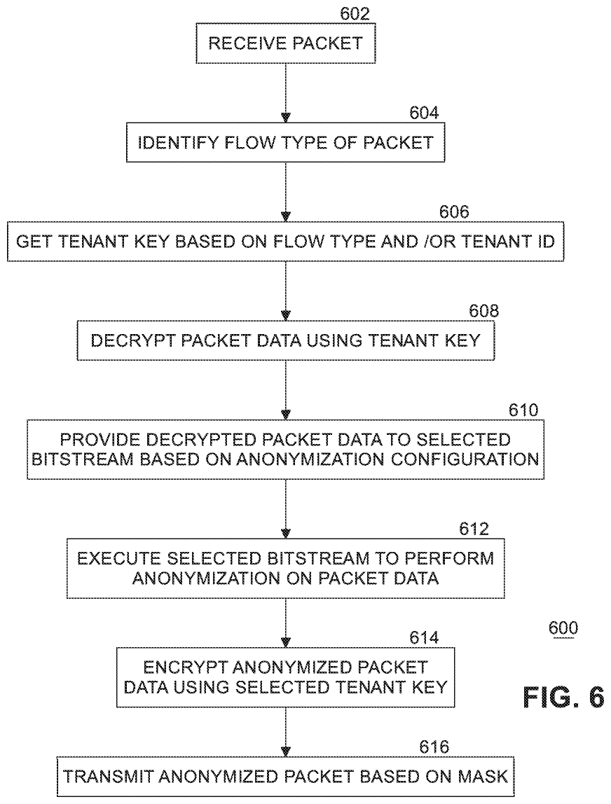

FIG. 6 illustrates an example flow diagram 600 of packet processing according to some embodiments. At block 602, packet processor 104 receives a packet 420. At block 604, anonymizer 410 identifies the packet flow type of the packet. At block 606, anonymizer 410 gets a tenant key from key manager 408 based at least in part on the packet flow type and/or a tenant ID in the packet. At block 608, anonymizer decrypts the packet using the tenant key. At block 608, anonymizer 410 provides the decrypted packet to a selected bitstream (e.g., in an FPGA or AI core) according to anonymization configuration 412. A bitstream is selected from anonymization configuration 412 based on tenant ID and packet flow type. In one embodiment, the selected bitstream, when executed, performs analytics operations on the packet data. In another embodiment, the selected bitstream, when executed, performs anonymization of the packet data. In an embodiment, packets may be grouped together by anonymizer 410 prior to sending to the selected bitstream for processing. Once all packets of a group are received, the selected bitstream by the accelerator circuitry such as one or more of FPGAs 414 and/or AI cores 416 as determined by anonymizer 410 from anonymization configuration 412 is executed to perform anonymization on packet data. At block 614, the anonymized packet(s) is encrypted by anonymizer 410 using the selected tenant key. At block 616, packet processor 104 transmits encrypted, anonymized packet 422 to a destination based on the mask.

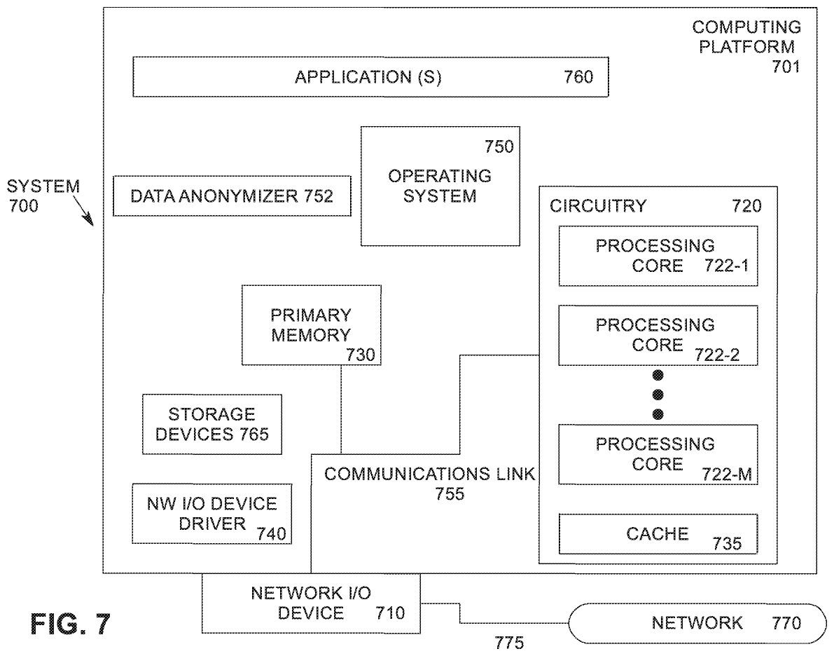

FIG. 7 illustrates an example computing system 700. As shown in FIG. 7, computing system 700 includes a computing platform 701 coupled to a network 770. In some examples, as shown in FIG. 7, computing platform 701 may couple to network 770 (which may be the same as network 202 of FIG. 2, e.g., the Internet) via a network communication channel 775 and through a network I/O device 710 (e.g., a network interface controller (NIC)) having one or more ports connected or coupled to network communication channel 775.

According to some examples, computing platform 701, as shown in FIG. 7, may include circuitry 720, primary memory 730, a network (NW) I/O device driver 740, an operating system (OS) 750, one or more application(s) 760, storage devices 765, and data anonymizer 752. In an embodiment, data anonymizer 106 of FIG. 1 is implemented as data anonymizer 752, and packets and packet metadata are stored in one or more of primary memory 730 and/or storage devices 765. In at least one embodiment, storage devices 765 may be one or more of hard disk drives (HDDs) and/or solid-state drives (SSDs). In an embodiment, storage devices 765 may be non-volatile memories (NVMs). In some examples, as shown in FIG. 7, circuitry 720 may communicatively couple to primary memory 730 and network I/O device 710 via communications link 755. Although not shown in FIG. 7, in some examples, operating system 750, NW I/O device driver 740 or application(s) 760 may be implemented, at least in part, via cooperation between one or more memory devices included in primary memory 730 (e.g., volatile or non-volatile memory devices) and elements of circuitry 720 such as processing cores 722-1 to 722-m, where “m” is any positive whole integer greater than 2. In an embodiment, data anonymizer 752 may be executed by one or more processing cores 722-1 to 722-m to process packets.

In some examples, computing platform 701, may include, but is not limited to, a server, a server array or server farm, a web server, a network server, an Internet server, a work station, a mini-computer, a main frame computer, a supercomputer, a network appliance, a web appliance, a distributed computing system, multiprocessor systems, processor-based systems, a laptop computer, a tablet computer, a smartphone, or a combination thereof. Also, circuitry 720 having processing cores 722-1 to 722-m may include various commercially available processors, including without limitation Intel® Atom®, Celeron®, Core (2) Duo®, Core i3, Core i5, Core i7, Itanium®, Pentium®, Xeon® or Xeon Phi® processors; ARM processors, AMD processors, and similar processors. Circuitry 720 may include at least one cache 735 to store data.

According to some examples, primary memory 730 may be composed of one or more memory devices or dies which may include various types of volatile and/or non-volatile memory. Volatile types of memory may include, but are not limited to, dynamic random-access memory (DRAM), static random-access memory (SRAM), thyristor RAM (TRAM) or zero-capacitor RAM (ZRAM). Non-volatile types of memory may include byte or block addressable types of non-volatile memory having a 3-dimensional (3-D) cross-point memory structure that includes chalcogenide phase change material (e.g., chalcogenide glass) hereinafter referred to as “3-D cross-point memory”. Non-volatile types of memory may also include other types of byte or block addressable non-volatile memory such as, but not limited to, multi-threshold level NAND flash memory, NOR flash memory, single or multi-level phase change memory (PCM), resistive memory, nanowire memory, ferroelectric transistor random access memory (FeTRAM), magneto-resistive random-access memory (MRAM) that incorporates memristor technology, spin transfer torque MRAM (STT-MRAM), or a combination of any of the above. In another embodiment, primary memory 730 may include one or more hard disk drives within and/or accessible by computing platform 701.

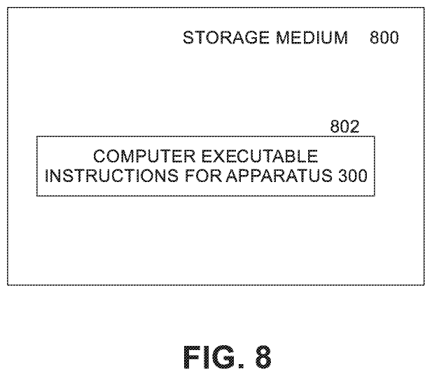

FIG. 8 illustrates an example of a storage medium 800. Storage medium 800 may comprise an article of manufacture. In some examples, storage medium 800 may include any non-transitory computer readable medium or machine readable medium, such as an optical, magnetic or semiconductor storage. Storage medium 800 may store various types of computer executable instructions, such as instructions 802 for apparatus 300 to implement logic flow 600 of FIG. 6. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

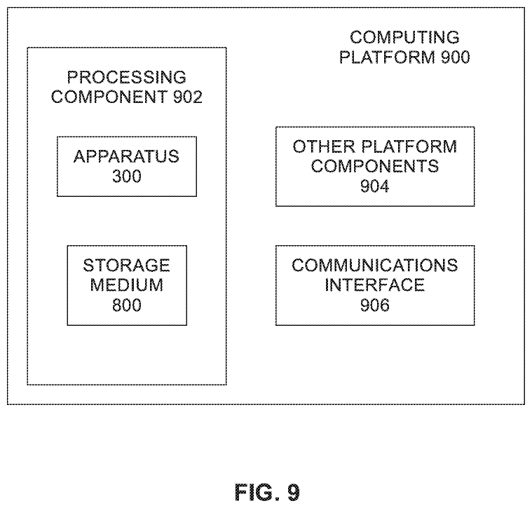

FIG. 9 illustrates an example computing platform 900. In some examples, as shown in FIG. 9, computing platform 900 may include a processing component 902, other platform components 904 and/or a communications interface 906.

According to some examples, processing component 902 may execute processing operations or logic for apparatus 300 and/or storage medium 800. Processing component 902 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, AI cores, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 904 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), types of non-volatile memory such as 3-D cross-point memory that may be byte or block addressable. Non-volatile types of memory may also include other types of byte or block addressable non-volatile memory such as, but not limited to, multi-threshold level NAND flash memory, NOR flash memory, single or multi-level PCM, resistive memory, nanowire memory, FeTRAM, MRAM that incorporates memristor technology, STT-MRAM, or a combination of any of the above. Other types of computer readable and machine-readable storage media may also include magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 906 may include logic and/or features to support a communication interface. For these examples, communications interface 906 may include one or more communication interfaces that operate according to various communication protocols or standards to communicate over direct or network communication links or channels. Direct communications may occur via use of communication protocols or standards described in one or more industry standards (including progenies and variants) such as those associated with the PCIe specification. Network communications may occur via use of communication protocols or standards such those described in one or more Ethernet standards promulgated by IEEE. For example, one such Ethernet standard may include IEEE 802.3. Network communication may also occur according to one or more OpenFlow specifications such as the OpenFlow Switch Specification.

The components and features of computing platform 900 may be implemented using any combination of discrete circuitry, ASICs, logic gates and/or single chip architectures. Further, the features of computing platform 900 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary computing platform 900 shown in the block diagram of FIG. 9 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one tangible, non-transitory machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASIC, programmable logic devices (PLD), digital signal processors (DSP), FPGAs, AI cores, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Included herein are logic flows or schemes representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow or scheme may be implemented in software, firmware, and/or hardware. In software and firmware embodiments, a logic flow or scheme may be implemented by computer executable instructions stored on at least one non-transitory computer readable medium or machine readable medium, such as an optical, magnetic or semiconductor storage. The embodiments are not limited in this context.

Some examples are described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A packet processor comprising:
accelerator circuitry to accelerate processing of packets; and
a data anonymizer, coupled to the accelerator circuitry, to
identify a type of a packet received by the packet processor;
get a tenant key based at least in part on the packet type or a tenant identifier (ID);
provide the packet data to a selected bitstream programmed into the accelerator circuitry;
execute the selected bitstream in the accelerator circuitry to anonymize the packet data; and
transmit the packet including the anonymized packet data according to a mask.

2. The packet processor of claim 1, the data anonymizer to decrypt the packet data using the tenant key before providing the packet data to the selected bitstream and to encrypt the anonymized packet data using the tenant key before transmitting the packet.

3. The packet processor of claim 1, wherein the accelerator circuitry comprises at least one field programmable gate array (FPGA).

4. The packet processor of claim 1, wherein the accelerator circuitry comprises an artificial intelligence (AI) core.

5. The packet processor of claim 1, the data anonymizer comprising an anonymization configuration to store associations of tenant IDs, packet flow types, masks, and bitstreams.

6. The packet processor of claim 1, wherein the selected bitstream, when executed, performs data analytics operations on the packet data.

7. The packet processor of claim 1, the data anonymizer comprising a registration manager to receive a registration command from a tenant, the registration command comprising the packet type, the selected bitstream, and the mask.

8. The packet processor of claim 7, wherein the registration command comprises the tenant key.

9. The packet processor of claim 7, wherein the data anonymizer loads the selected bitstream into the accelerator circuitry after receipt of the registration command.

10. The packet processor of claim 1, wherein the selected bitstream anonymizes the packet data from multiple packets at a time.

11. The packet processor of claim 1, wherein the selected bitstream comprises binary code.

12. The packet processor of claim 1, wherein the mask comprises a destination Internet Protocol (IP) address.

13. A method of operating a packet processor comprising:
receiving a packet;
identifying a type of the packet;
getting a tenant key based at least in part on the packet type or a tenant identifier (ID);
providing the packet data to a selected bitstream programmed into accelerator circuitry;
executing the selected bitstream in the accelerator circuitry to anonymize the packet data; and
transmitting the packet including the anonymized packet data according to a mask.

14. The method of claim 13, comprising decrypting the packet data using the tenant key before providing the packet data to the selected bitstream and encrypting the anonymized packet data using the tenant key before transmitting the packet.

15. The method of claim 13, wherein the accelerator circuitry comprises at least one field programmable gate array (FPGA).

16. The method of claim 13, wherein the accelerator circuitry comprises an artificial intelligence (AI) core.

17. The method of claim 13, comprising storing associations of tenant IDs, packet types, masks, and bitstreams in an anonymization configuration.

18. The method of claim 13, comprising performing data analytics operations on the packet data when the selected bitstream is executed.

19. The method of claim 13, comprising receiving a registration command from a tenant, the registration command comprising the packet type, the selected bitstream, and the mask.

20. The method of claim 19, wherein the registration command comprises the tenant key.

21. The method of claim 19, comprising loading the selected bitstream into the accelerator circuitry after receipt of the registration command.

22. The method of claim 13, wherein the selected bitstream anonymizes the packet data from multiple packets at a time.

23. The method of claim 13, wherein the selected bitstream comprises binary code.

24. The method of claim 13, wherein the mask comprises a destination Internet Protocol (IP) address.

25. At least one non-transitory machine-readable medium comprising a plurality of instructions that in response to being executed by a processor in a packet processing system cause the system to:
receive a packet by the packet processing system;
identify a packet type of the packet;
get a tenant key based at least in part on the packet type or a tenant identifier (ID);
provide the packet data to a selected bitstream programmed into accelerator circuitry;
execute the selected bitstream in the accelerator circuitry to anonymize the packet data; and
transmit the packet including the anonymized packet data according to a mask.

26. The at least one non-transitory machine-readable medium of claim 25, comprising instructions, that when executed, decrypt the packet data using the tenant key before providing the packet data to the selected bitstream and encrypt the anonymized packet data using the tenant key before transmitting the packet.

27. The at least one non-transitory machine-readable medium of claim 25, comprising instructions, that when executed, store associations of tenant IDs, packet flow types, masks, and bitstreams in an anonymization configuration.

28. The at least one non-transitory machine-readable medium of claim 25, comprising instructions, that when executed, receive a registration command from a tenant, the registration command comprising the packet type, the selected bitstream, and the mask.

29. The at least one non-transitory machine-readable medium of claim 28, wherein the registration command comprises the tenant key.

30. The at least one non-transitory machine-readable medium of claim 28, comprising instructions, that when executed, load the selected bitstream into the accelerator circuitry after receipt of the registration command.
